(19) United States
(12) Patent Application Publication
(10) Pub. No.: US 2012/0111791 A1
(43) Pub. Date: May 10, 2012

(54) Surface Deposition of Small Molecules to Increase Water Purification Membrane Fouling Resistance

(75) Inventors: Benny D. Freeman, Austin, TX (US); Daniel J. Miller, Austin, TX (US); Bryan D. McCloskey, Campbell, CA (US); Christopher W. Bielawski, Austin, TX (US); Daniel R. Dreyer, Austin, TX (US)

(73) Assignee: Board of Regents, The University of Texas System, Austin, TX (US)

(21) Appl. No.: 12/939,764

(22) Filed: Nov. 4, 2010

(51) Int. Cl. B01D 65/08; B05D 5/00; B01D 71/06

(52) U.S. Cl. 210/500.34; 210/500.33; 427/244

(57) ABSTRACT

The present invention includes methods and compositions for liquid separation and water purification. The present invention includes a purification membrane having a polymer matrix purification membrane that has been treated with hydroquinone, catechol, and/or dopamine coated membrane with a high water flux.

### STATEMENT OF FEDERALLY FUNDED RESEARCH

None.

### CROSS-REFERENCE TO RELATED APPLICATIONS

None.

### INCORPORATION-BY-REFERENCE OF MATERIALS FILED ON COMPACT DISC

None.

### TECHNICAL FIELD OF THE INVENTION

The present invention relates in general to the field of membranes for water purification, and more particularly to the deposition of polymers and modification of membrane surfaces to reduce fouling on membranes.

### BACKGROUND OF THE INVENTION

Without limiting the scope of the invention, its background is described in connection with membranes for water purification. A significant problem facing membrane-based water purification systems is membrane fouling. Fouling occurs when certain impurities in water deposit on a membrane's surface or in its internal pore structure. This deposition leads to a dramatic reduction in water flux, which increases operating costs and decreases membrane lifetime. Therefore, new membrane materials need to be developed to help reduce foulant adhesion. Here, we have used a deposition technique to apply hydroquinone, catechol, or mixtures of hydroquinone, catechol, and/or dopamine onto the surface of commercial microfiltration, ultrafiltration, nanofiltration, and reverse osmosis membranes. Application of hydroquinone, catechol, or mixtures of hydroquinone, catechol, and/or dopamine to the membrane surface leads to a reduction in membrane fouling.

There have been many other studies that have explored membrane surface modification to alleviate membrane fouling. However, these studies mainly focused on grafting or coating hydrophilic molecules to a specific support membrane. Many of these techniques are not applicable to multiple types of water purification membranes and many require commercially unviable treatment steps such as plasma treatment.

### SUMMARY OF THE INVENTION

The present invention provides a deposition method used to coat membranes with hydroquinone, catechol, or mixtures of hydroquinone, catechol, and/or dopamine which is advantageous over other modifications because of its ease of applicability to many membrane supports. The deposition process occurs by simply dissolving hydroquinone, catechol, or mixtures of hydroquinone, catechol, and/or dopamine in a slightly alkaline water solution (pH=8-10) and dipping a membrane into the solution for an extended period of time (up to 16 hrs).

The present invention provides a method of decreasing membrane fouling by depositing a coating composition on a membrane to form a coated membrane, wherein the coating composition comprises hydroquinone, catechol, hydroquinone and catechol, hydroquinone and dopamine, catechol and dopamine, or hydroquinone, catechol, and dopamine, wherein the coated membrane has a higher water flux than an unmodified membrane.

The present invention includes a purification membrane; a coating layer in contact with the purification membrane to form a coated purification membrane with a high water flux wherein the coating layer comprises hydroquinone, catechol, or mixtures of hydroquinone, catechol, and/or dopamine.

### BRIEF DESCRIPTION OF THE DRAWINGS

For a more complete understanding of the features and advantages of the present invention, reference is now made to the detailed description of the invention along with the accompanying figures and in which:

FIG. 1 is a drawing of the experimental apparatus on which the data of FIGS. 2, 3, and 4 was collected.

FIG. 2 is a graph of the fouling results for polytetrafluoroethylene (PTFE) MF membrane modified with hydroquinone, catechol, and dopamine.

FIG. 3 is a graph of the fouling results for similarly-modified polysulfone (PSf) ultrafiltration (UF) membrane showing similar results.

FIG. 4 is a graph of the fouling results for similarly-modified poly(ether sulfone) (PES) ultrafiltration (UF) membrane showing similar results.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

A significant problem facing membrane-based water purification systems is membrane fouling. Fouling occurs when certain impurities in water deposit on a membrane's surface or in its internal pore structure. This deposition leads to a dramatic reduction in water flux which increases operating costs and decreases membrane lifetime. Therefore, new membrane materials need to be developed to help reduce foulant adhesion. Most studies have focused on increasing membrane hydrophilicity as a method to eliminate fouling as foulants are mostly organic compounds that a have a high binding affinity with hydrophobic surfaces. Here, we have used a deposition technique to apply mixtures of small, hydrophilic molecules to the surface of commercial microfiltration, ultrafiltration, nanofiltration, and reverse osmosis membranes. Application of these molecules to the membrane surface reduces membrane fouling.

The deposition technique described here has over other surface modification technologies is its ability to be applicable to many membranes comprised of different materials. Most other surface modifications are exclusive to particular membranes. The molecules used in this invention deposit onto nearly any surface with they come into contact which allows their use on many different membranes.

Strong depositions of hydrophilic, neutral small molecules are ideally suited to alleviate fouling on water purification membrane surfaces. Hydrophilic polymer coatings have been of recent interest in the membrane community, but delamination is a problem when using polymeric coatings on a hydrophobic membrane as the hydrophilic polymer swells in water. The chemical structures of the small molecules here employed lead to high hydrogen bonding with the membrane support.

A family of hydrophilic, neutrally-charged (pH=7) small molecules can deposit on many surfaces with which they come into contact. Therefore, they have potential to be widely used as effective anti-fouling coating layers in many membrane water purification applications.

The hydroxyl groups present on some small molecules may enable conjugation of other molecules to a modified membrane surface. Therefore, this surface modification could be used as an intermediate layer between a hydrophobic membrane and a hydrophilic polymeric coating permitting improved adhesion of the hydrophilic layer to the membrane support allowing long-term membrane operation. This will reduce defects in a hydrophilic coating layer as the solution used to coat the membrane will easily wet the membrane surface. A membrane coating layer could further reduce fouling by not allowing foulants to come into contact with the porous structure of the underlying membrane. The binding of hydrophilic layers to hydrophobic membranes also could serve a practical purpose in other membrane applications, including pervaporation and gas separations, in which the swellability of the hydrophilic polymer is an issue.

As used herein the term “molecule” is used to refer to a combination of two or more atoms in a definite arrangement held together by covalent chemical bonds and is generally considered the smallest particle of a pure substance that still retains its composition and chemical properties.

As used herein the term “water flux” or “flux” is used to refer to the volume of solution (e.g., water, clean water etc.) flowing through a given membrane area during a given time.

In addition, the individual monomer, copolymers, subunits or polymers may be substituted with one or more molecules, groups or atoms. The number, position, location and type of modification may be varied by the skilled artisan. The modifications may include the addition of one or more of the following groups: lower alkyl, alkenyl, amino, aryl, alkylaryl, halogen, halo, haloalkyl, phosphoryl or combination thereof. The skilled artisan will recognize that modified or substituted hydroquinone, catechol, or dopamine will form a substituted coating on the membrane surface. The substitution may be one or more lower alkyl groups, alkenyl groups, amino groups, aryl groups, alkylaryl groups, halogen groups, halo groups, haloalkyl groups, phosphoryl groups or combination thereof. The substituted coating may have one or more groups and the groups may be similar or different groups.

The present invention includes a deposition method used to treat membranes with hydroquinone, catechol, or mixtures of hydroquinone, catechol, and/or dopamine on the membrane surface and in the case of porous membranes, inside the membrane pores. This method is advantageous over other modifications because of its ease of applicability to virtually any membrane support. The deposition process occurs by dissolving hydroquinone, catechol, or mixtures of hydroquinone, catechol, and/or dopamine in an alkaline water solution (e.g., from a pH of about 8 to a pH of 14) and immersing a membrane into the solution for a certain period of time (e.g., 1 minute to multiple days). The skilled artisan will appreciate that the length of time of exposure of the membrane to the hydroquinone, catechol, and/or dopamine solution may be varied to change the amount of hydroquinone, catechol, and/or dopamine deposited on the membrane surface. For example, one can use a hydroquinone, catechol, or dopamine solution concentration of 2 mg of hydroquinone, catechol, or dopamine per ml of tris(hydroxymethyl)aminomethane (TRIS) aqueous buffer (pH=8-10). The skilled artisan will appreciate that the hydroquinone, catechol, and/or dopamine concentration can be varied, as can the buffer solution used and that the hydroquinone, catechol, and/or dopamine can be applied from an alkaline aqueous solution with no buffer if desired, to vary the amount of hydroquinone, catechol, and/or dopamine deposited onto the membrane. Under these conditions, the hydroquinone, catechol, and dopamine nonspecifically adhere to virtually any surface with which they come into contact.

In addition to being a hydroquinone, catechol, and/or dopamine layer deposited onto the membrane or a membrane composition having hydroquinone, catechol and/or dopamine, the present invention includes layers and composition having hydroquinone and/or catechol and dopamine as an additive. When the hydroquinone, catechol and/or dopamine are in the form of an additive, the actual concentration will be a percentage of the total concentration and may be from 0.001 to 50 percent. For example, the additive concentration may be 0.1, 0.2, 0.3, 0.4, 0.5, 1, 2, 3, 4, 5, 10, 15, 20, 30, 40, to 50 percent. As the percentage listed here are for example it should be understood that the skilled artisan contemplates the use of as an additive for each and every value listed between 0.001 and 50, e.g., 37.45% and 14.96%.

The present inventors recognized that in order for sufficient layer to deposit on a membrane surface it takes a significant amount of time. For example, the present inventors used samples that had been immersed in solution for 60 minutes for use in anti-fouling studies. Although this is not exceedingly long, for industrial practicality, shorter or longer immersion times may be deemed optimal. The present inventors recognized that depending on many factors, the membrane immersion in the hydroquinone, catechol, and/or dopamine solution may be varied from 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 50, 60, 120 or more than 120 minutes depending on factors such as solution pH, concentration, substrate material temperature, and so forth.

The hydroquinone, catechol and/or dopamine composition of the instant invention, can deposit on virtually any surface with which it comes into contact. Therefore, it has potential to be widely used as an effective anti-fouling coating layer in many membrane water purification applications. The present inventors recognized that a hydroquinone, catechol, and/or dopamine layer resists fouling when deposited on reverse osmosis (RO) polyamide, nanofiltration (NF) polyamide, and ultrafiltration (UF) polysulfone membranes. However, the skilled artisan will appreciate that if the composition can positively influence the fouling characteristics of these membranes, it should also positively influence the fouling characteristics of other membranes and filter media, such as microfiltration (MF) membranes.

The present invention includes a method of decreasing membrane fouling by depositing a hydroquinone, catechol, and/or dopamine coating on a membrane. The coated membrane has a high water flux and an increased membrane surface hydrophilicity.

The support membrane used for modification may include one or more of the following: polymethylmethacrylates, polystyrenes, polycarbonates, polyimides, epoxy resins, cyclic olefin copolymers, cyclic olefin polymers, acrylate polymers, polyethylene teraphthalate, polyphenylene vinylene, polyether ether ketone, poly(N-vinylcarbazole), acrylonitrile-styrene copolymer, or polyetherimide poly(phenylenevinylene), polysulfones, sulfonated polysulfones, copolymers of styrene and acrylonitrile poly(arylene oxide), polycarbonate, cellulose acetate, piperazine-containing polymers, polyelectrolytes, poly(styrenes), styrene-containing copolymers, acrylonitrilestyrene copolymers, styrene-butadiene copolymers, styrene-vinylbenzylhalide copolymers; polycarbonates; cellulosic polymers, cellulose acetate-butyrate, cellulose propionate, ethyl cellulose, methyl cellulose, nitrocellulose, polyamides, polyimides, aryl polyamides, aryl polyimides, polyethers, poly(arylene oxides), poly(phenylene oxide), poly(xylene oxide); poly(esteramide-diisocyanate), polyurethanes, polyesters (including polyarylates), poly(ethylene terephthalate), poly(alkyl methacrylates), poly(acrylates), poly(phenylene terephthalate), polysulfides, poly(ethylene), poly(propylene), poly(butene-1), poly(4-methyl pentene-1), polyvinyls, poly(vinyl chloride), poly(vinyl fluoride), poly(vinylidene chloride), poly(vinylidene fluoride), poly(vinyl alcohol), poly(vinyl esters), poly(vinyl acetate), poly(vinyl propionate), poly(vinyl pyridines), poly(vinyl pyrrolidones), poly(vinyl ethers), poly(vinyl ketones), poly(vinyl aldehydes), poly(vinyl formal), poly(vinyl butyral), poly(vinyl amides), poly(vinyl amines), poly(vinyl urethanes), poly(vinyl ureas), poly(vinyl phosphates), poly(vinyl sulfates), polyallyls; poly(benzobenzimidazole), polyhydrazides, polyoxadiazoles, polytriazoles, poly(benzimidazole), polycarbodiimides, polyphosphazines and combinations thereof.

One example includes hydroquinone, catechol, dopamine, or a mixture thereof dissolved at a concentration of 2 mg/mL in aqueous Trizma hydrochloride buffer at pH=8.8. The membrane surface is brought into contact with this solution for a specified period of time but typically less than 16 hours. The membrane modification is effective at other small molecule concentrations, buffer concentrations, pH, and application times. Some materials include catechol, hydroquinone and dopamine mixture, catechol and dopamine mixture, hydroquinone and dopamine mixture. Molecules like “hydroquinone” and “catechol” are able to form charge transfer complexes with their own oxidation products. These products form spontaneously during the membrane modification. Hydroquinone forms a charge transfer complex with its oxidation product 1,4-benzoquinone (e.g., quinhydrone). Catechol forms a charge transfer complex with its oxidation product 1,2-benzoquinone. As used herein “hydroquinone” or “catechol,” is used to denote the molecules themselves, their spontaneous oxidation products, or the charge-transfer complexes which form between them and their spontaneous oxidation product.

Alternative solvents for the dopamine polymerization reaction include the solvents are listed in the table below. Trizma HCl buffer (15 mM) and NaOH were dissolved in each. The amount of NaOH is approximated based on the amount of NaOH typically required for reaction in aqueous media. Dopamine (2 mg/mL) was dissolved in each mixture and reacted for 48 hours.

| Solvent | Result |
|---|---|
| Water | Rapid color change to dark |
| | brown |
| Ethylene glycol | Slow color change (after ~12 |
| | hours) to dark brown |
| Glycerol | Slow color change (after ~12 |
| | hours) to light brown |
| Methanol | Moderately fast color |
| | change to medium brown |
| Poly(ethylene glycol) | Moderately fast color |
| (MW = 600)* | change to light brown |

Any molecular weight PEG that is liquid at room temperature maybe used, e.g., PEG could be any molecular weight less than approximately 1000 g/mol.

One buffer that may be used is a Triszma HCl buffer; however, other buffers may be used. For example, aqueous buffer solutions at 15 mM and pH=8.8 (except where noted) were prepared. Dopamine (2 mg/mL) was dissolved in each and the reactions were allowed to proceed overnight. A summary of the results are presented in the table below.

| Buffer | Result |
|---|---|
| Trizma hydrochloride | Rapid color change to |
| | dark brown |
| N-[Tris(hydroxymethyl)methyl]-3- | Rapid color change to |
| aminopropanesulfonic acid (TAPS) | dark brown |
| 1,3-Bis[tris(hydroxymethyl)methyl- | Rapid color change to |
| amino]propane (BIS-TRIS propane) | dark brown |
| 2-(Cyclohexylamino)ethanesulfonic | Rapid color change to |
| acid (CHES) | dark brown |
| Phosphate-buffered saline (PBS) | Lighter color than Tris |
| N,N-Bis(2-hydroxyethyl)glycine (BICINE) | Rapid color change to |
| | dark brown |
| N-[Tris(hydroxymethyl)methyl]glycine | Rapid color change to |
| (TRICINE) | dark brown |
| Triethylammonium bicarbonate | Moderately rapid change |
| (0.1M, pH = 8.5) | to deep red-brown color |
| Britton-Robinson Buffer | Moderately rapid change |
| CH3COOH (0.04M) | to light brown |
| H3BO3 (0.04M) | |
| H3PO4 (0.04M) | |
| Carbonate-Bicarbonate Buffer | Moderately rapid change |
| | to dark brown |
| NaOH solution | Very slow |

The inventors have elucidated the structure of polydopamine, which was prepared by treating a dilute aqueous solution of dopamine HCl with tris base (pKa=8.06; pKb=5.94), as shown below. The product was purified by dialysis against deionized water for 1 week (water changed daily, or more) and isolated by rotary evaporation.

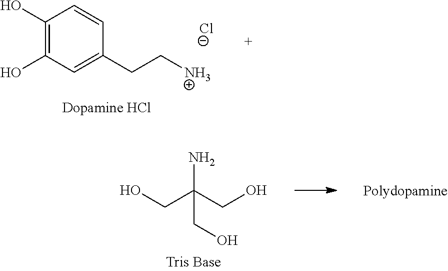

A guiding body of work in this study has been that related to quinhydrone chemistry, where mixtures of benzoquinones and benzohydroquinones form supramolecular networks. Notably, however, in addition to their linearly aligned hydrogen bonds, these structures pi-stack, affording 3-dimensional supramolecular polymers. Such behavior is likely also possible in the case of polydopamine, hydroquinone, and catechol membrane coatings. Depending on the quinone/hydroquinone pair, solvent, and other reaction conditions, these materials can be either intractable (as is polydopamine) or fully soluble if the interaction is thermodynamically unfavorable.

Covalent bonding does not appear to be a likely chemical structure in polydopamine. It is difficult to envision chemistry that would allow for C—C bond formation, particularly if the proposed mechanism involves thermodynamically disfavored dearomatization of the dopamine core.

In the present invention the cyclization of dopamine to its corresponding indoline is supported by ¹³C and ¹⁵N ssNMR data. Cross-polarization transfer in the ¹³C-enriched product indicates that the protons present on the aromatic core of the starting material are retained in the product and that arene-arene linkages are likely not a dominant structural motif. Delocalization of the electronic structure is supported by FT-IR data (as evidenced by the disappearance of the ketone stretch at approximately 1700 cm⁻¹). PXRD indicated the presence of weak π-stacking, possibly formed through charge transfer complexation. Pycnometry indicated an appreciable increase in density upon the polymerization of dopamine, as is seen in the polymerization of most monomers. Unexpectedly, elemental analysis indicates that chlorine is incorporated into the structure of polydopamine, though it is not clear if this is via ionic or covalent bonds. The basicity of the indoline (perhaps present as a radical anion) moiety may indicate these species are present as chloride anions.

The data collected so far support chemical behavior analogous to that seen in quinhydrones, where supramolecular polymers are formed as a result of both hydrogen bonding and π-stacking. More complex behavior, such as the coupling of the aromatic rings, does not seem consistent with these results and in some embodiments the polydopamine is best described as a predominately indolinium-type supramolecular polymer (as shown below) with few, if any, covalent linkages between monomers.

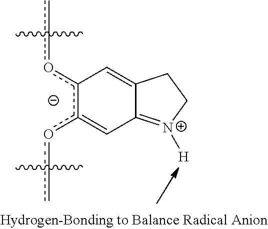

The membrane being modified may be in part or entirely made of one or more polymers. For example, the polymer surface may include Polyethylene (PE); Polypropylene (PP); Polystyrene (PS); Polyethylene terephthalate (PET or PETE); Polyamide (PA); Polysulfone; Sulfonated polysulfone or any other polyelectrolyte that is suitable for membrane use; Polyester Polyvinyl chloride (PVC); Polycarbonate (PC); Acrylonitrile butadiene styrene (ABS); Polyvinylidene chloride (PVDC); Polytetrafluoroethylene (PTFE); Polymethyl methacrylate (PMMA); Polylactic acid (PLA), Polypiperazine, and combinations thereof. In addition, the Polyethylene (PE); Polypropylene (PP); Polystyrene (PS); Polyethylene terephthalate (PET or PETE); Polyamide (PA); Polyester Polyvinyl chloride (PVC); Polycarbonate (PC); Acrylonitrile butadiene styrene (ABS); Polyvinylidene chloride (PVDC); Polytetrafluoroethylene (PTFE); Polymethyl methacrylate (PMMA); Polylactic acid (PLA) may be modified, substituted or altered by the skilled artisan.

In addition, the polymer may be made from one or more monomers selected from: methyl acrylate, ethyl acrylate, propyl acrylate (all isomers), butyl acrylate (all isomers), 2-ethylhexyl acrylate, isobornyl acrylate, acrylic acid, benzyl acrylate, phenyl acrylate, acrylonitrile, glycidyl acrylate, 2-hydroxyethyl acrylate, hydroxypropyl acrylate (all isomers), hydroxybutyl acrylate (all isomers), diethylaminoethyl acrylate, triethyleneglycol acrylate, N-tert-butyl acrylamide, N-n-butyl acrylamide, N-methyl-ol acrylamide, N-ethyl-ol acrylamide, trimethoxysilylpropyl acrylate, triethoxysilylpropyl acrylate, tributoxysilylpropyl acrylate, dimethoxymethylsilylpropyl acrylate, diethoxymethylsilylpropyl acrylate, dibutoxymethylsilylpropyl acrylate, diisopropoxymethylsilylpropyl acrylate, dimethoxysilylpropyl acrylate, diethoxysilylpropyl acrylate, dibutoxysilylpropyl acrylate, diisopropoxysilylpropyl acrylate, vinyl acetate, styrene, diethylamino styrene, para-methylstyrene, vinyl benzoic acid, vinyl benzene sulfonic acid, vinyl propionate, vinyl butyrate, vinyl benzoate, vinyl chloride, vinyl fluoride, vinyl bromide, methyl methacrylate, ethyl methacrylate, propyl methacrylate, butyl methacrylate, 2-ethylhexyl methacrylate, isobornyl methacrylate, methacrylic acid, benzyl methacrylate, phenyl methacrylate, methacrylonitrile, alpha methyl styrene, trimethoxysilylpropyl methacrylate, triethoxysilylpropyl methacrylate, tributoxysilylpropyl methacrylate, dimethoxymethylsilylpropyl methacrylate, diethoxymethyl-silylpropylmethacrylate, dibutoxymethylsilylpropyl methacrylate, diisopropoxymethylsilylpropyl methacrylate, dimethoxysilylpropyl methacrylate, diethoxysilylpropyl methacrylate, dibutoxysilylpropyl methacrylate, diisopropoxysilylpropyl methacrylate, isopropenyl butyrate, isopropenyl acetate, isopropenyl benzoate, isopropenyl chloride, isopropenyl fluoride, isopropenyl bromideitaconic aciditaconic anhydridedimethyl itaconate, methyl itaconate N-tert-butyl methacrylamide, N-n-butyl methacrylamide, N-methyl-ol methacrylamide, N-ethyl-ol methacrylamide, isopropenylbenzoic acid, diethylamino alphamethylstyrene, para-methyl-alpha-methylstyrene, diisopropenylbenzene, isopropenylbenzene sulfonic acid, methyl 2-hydroxymethylacrylate, ethyl 2-hydroxymethylacrylate, propyl 2-hydroxymethylacrylate, butyl 2-hydroxymethylacrylate, 2-ethylhexyl 2-hydroxymethylacrylate, isobornyl 2-hydroxymethylacrylate, and dimethyl Meta-Isopropenylbenzyl Isocyanate. In some embodiments, the polymer may be inpart or entirely made from poly(1-phenyl-2-[p-trimethylsilylphenyl]acetylene, poly(1-trimethylsilyl-1-propyne), poly(ethylene octene), crosslinked poly(ethylene oxide), and 1,2-polybutadiene.

The polymers of the present invention may be modified and/or substituted with one or more halogens, hydroxyl groups, lower alkyl groups, lower alkoxy groups, monocyclic aryl, lower acyl groups and combinations thereof. Furthermore, one or more functional groups for the polymer may be chosen from ROOH, ROSH, RSSH, OH, SO₃H, SO₃R, SO₄R, COOH, NH₂, NHR, NR₂, CONH₂, and NH—NH₂, wherein R denotes, e.g., linear or branched hydrocarbon-based chains, capable of forming at least one carbon-based ring, being saturated or unsaturated; alkylenes, siloxanes, silanes, ethers, polyethers, thioethers, silylenes, and silazanes.

The polymers may include rubbery polymers, stiff chain polymers, glassy polymers and combinations thereof including: poly(1-phenyl-2-[p-trimethylsilylphenyl]acetylene (hereafter referred to as “PTMSDPA”) and poly(1-trimethylsilyl-1-propyne) (hereafter referred to as “PTMSP”) and elastomeric and rubbery polymers including poly(ethylene octene). Other polymers suitable for the present invention can be substituted or unsubstituted polymers and may include polysulfone, copolymer of styrene and acrylonitrile poly(arylene oxide), polycarbonate, and cellulose acetate, polysulfones; poly(styrenes), including styrene-containing copolymers such as acrylonitrilestyrene copolymers, styrene-butadiene copolymers and styrene-vinylbenzylhalide copolymers; polycarbonates; cellulosic polymers, such as cellulose acetate-butyrate, cellulose propionate, ethyl cellulose, methyl cellulose, nitrocellulose, etc.; polyamides and polyimides, including aryl polyamides and aryl polyimides; polyethers; poly(arylene oxides) such as poly(phenylene oxide) and poly(xylene oxide); poly(esteramide-diisocyanate); polyurethanes; polyesters (including polyarylates), such as poly(ethylene terephthalate), poly(alkyl methacrylates), poly(acrylates), poly(phenylene terephthalate), etc.; polysulfides; polymers from monomers having alpha-olefinic unsaturation other than mentioned above such as poly(ethylene), poly(propylene), poly(butene-1), poly(4-methyl pentene-1), polyvinyls, e.g., poly(vinyl chloride), poly(vinyl fluoride), poly(vinylidene chloride), poly(vinylidene fluoride), poly(vinyl alcohol), poly(vinyl esters) such as poly(vinyl acetate) and poly(vinyl propionate), poly(vinyl pyridines), poly(vinyl pyrrolidones), poly(vinyl ethers), poly(vinyl ketones), poly(vinyl aldehydes) such as poly(vinyl formal) and poly(vinyl butyral), poly(vinyl amides), poly(vinyl amines), poly(vinyl urethanes), poly(vinyl ureas), poly(vinyl phosphates), and poly(vinyl sulfates); polyallyls; poly(benzobenzimidazole); polyhydrazides; polyoxadiazoles; polytriazoles; poly(benzimidazole); polycarbodiimides; polyphosphazines; etc., and interpolymers, including block interpolymers having repeating units from the above such as terpolymers of acrylonitrile-vinyl bromide-sodium salt of para-sulfophenylmethallyl ethers; and grafts and blends having any of the foregoing. Substituents providing substituted polymers include halogens such as fluorine, chlorine and bromine; hydroxyl groups; lower alkyl groups; lower alkoxy groups; monocyclic aryl; lower acyl groups and the like.

In addition, the polymers, monomers or copolymer may be modified by the addition or substitution of one or more of the following groups: lower alkyl, alkenyl, amino, aryl, alkylaryl, halogen, halo, haloalkyl, phosphoryl or combination thereof. In addition, the modification may be similarly modified with one or more lower alkyl, alkenyl, amino, aryl, alkylaryl, halogen, halo, haloalkyl, phosphoryl or combination thereof.

In addition, the polymers, monomers or copolymer may include monomers that are hydrophilic and/or hydrophobic and may be cross-linked to form polymer films and/or membranes. The skilled artisan will recognize that by varying the degree of cross-linking of the polymers, the polymers can have very high concentrations of ionic groups (i.e., sulfonic acid) without a high water uptake. In addition, the present invention may include sulfonated polymer structures and substrates. For example, current sulfonated polymer membranes for reverse osmosis applications display stability over a pH range of about 4 to about 11, with a high water flux and high chlorine tolerance.

Due to their hydrophilicity and neutral charge, hydroquinone, catechol, and dopamine are ideally suited to alleviate fouling when used to modify water purification membranes' surfaces. Furthermore, delamination is a problem when using highly hydrophilic polymer coating on a hydrophobic membrane because the hydrophilic polymer will swell in water. The chemical structures of hydroquinone and catechol (each containing two hydroxyl groups) lead to high hydrogen bonding with the membrane support. These hydrogen bonds ensure high binding so that delamination of the coating layer does not occur.

The biggest advantage that hydroquinone, catechol, and/or dopamine deposition have over other surface modification technologies is their applicability to many membranes comprised of different materials. Most other surface modifications are exclusive to particular membranes. Hydroquinone, catechol, and dopamine deposit onto nearly any surface with they come into contact, which allows their use on many different membranes.

The deposition of hydroquinone, catechol, or mixtures of hydroquinone, catechol, and/or dopamine onto the membrane surface is a relatively slow process. Presently, membranes have been modified by deposition of hydroquinone, catechol, or mixtures of hydroquinone, catechol, and/or dopamine for two hours. Shorter or longer deposition times may be used. Factors such as solution pH, temperature and hydroquinone, catechol, and/or dopamine concentrations can be modified to optimize deposition time.

The hydroxyl groups present in hydroquinone, catechol, and dopamine may enable conjugation of other molecules to a modified membrane surface. Hydroquinone, catechol, and dopamine could be used as an intermediate layer between a membrane and a hydrophilic coating permitting improved adhesion of the hydrophilic layer to the membrane support allowing long-term membrane operation. A membrane coating layer could further reduce fouling by not allowing foulants to come into contact with the porous structure of the underlying membrane.

Membranes were modified using solutions of hydroquinone, catechol, and/or dopamine. Membranes were first prepared by soaking in isopropyl alcohol for 30 minutes followed by soaking in ultrapure water for 30 minutes to remove any residual chemicals from manufacture. The membranes were removed from water and placed active side-up on a glass plate. One edge of a glass casting ring of 5″ diameter was lightly coated with vacuum grease and pressed onto the active side of the membrane to form a tight seal. Buffer solution was prepared by dissolving 2.634 g of Trizma HCl in one liter of ultrapure water and adjusting the pH to 8.8 with NaOH. The solution used for membrane modification was prepared by dissolving 100 mg of hydroquinone, catechol, and/or dopamine with 50 mL of the buffer solution. The modification solution was poured into the glass casting ring atop the membrane and the membrane was gently rocked for eight hours at room temperature (open to the atmosphere). Over this period, the modification solution and the membrane surface in contact with the solution turned brown. After eight hours, the membrane surface was rinsed with gently running ultrapure water and the glass casting ring was removed. Samples for fouling studies (1.5″×3.5″) were cut from the center of the modified membrane.

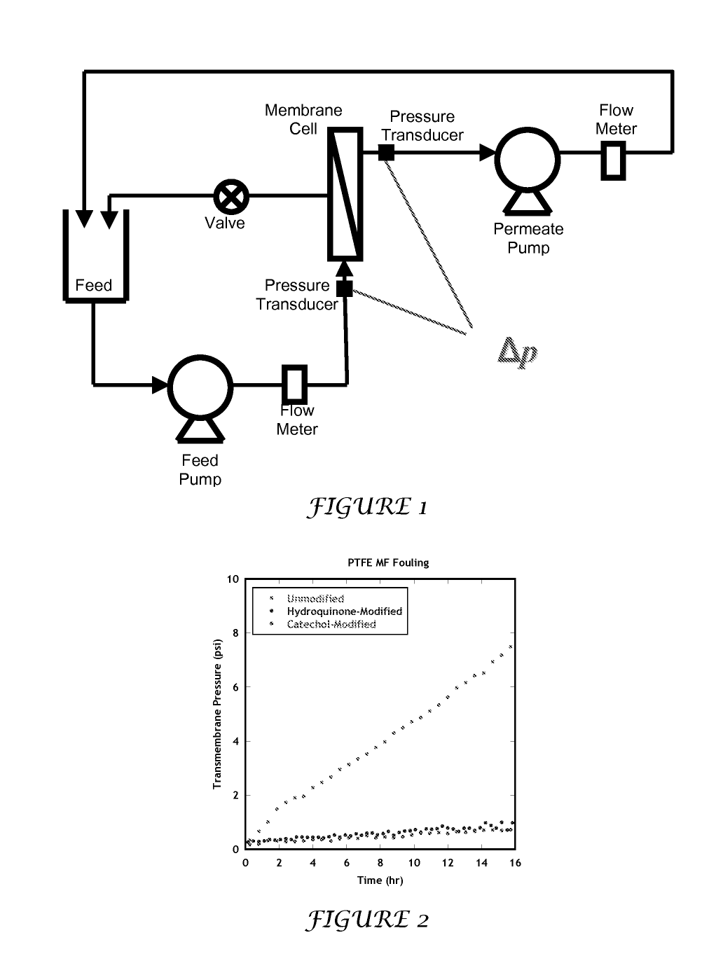

FIG. 1 is a general schematic of the device used in the studies of this application. Fouling studies were carried out using a 1500 ppm soybean oil emulsion which is prepared by vigorously mixing 10.8 g soybean oil with 1.2 g Dow Corning DC193 surfactant in eight liters of ultrapure water for three minutes. Oil droplet size was in the range of 1-3 μm. The emulsion was used as the feed solution in constant-flux fouling studies.

The feed pump is used to control the feed crossflow velocity and the valve is used to control the feed side pressure. The permeate pump is used to maintain a constant permeate flux at all times during the study. Membrane fouling behavior is evaluated by the transmembrane pressure difference which develops between the feed and permeate lines (indicated by Δp in the diagram). As the membrane fouls, the pressure of the permeate line decreases, increasing Δp. As fouling worsens, Δp increases.

FIG. 2 is a graph of the fouling results for Poly(ether sulfone) (PTFE) ultrafiltration (UF) membranes. In both cases, however, modification with hydroquinone and catechol resulted in a significant improvement in membrane fouling resistance. Constant flux fouling results are shown below. In both cases, the crossflow velocity was 120 L/hr, the feed side pressure was 27 psia and the permeate flux was 75 Lin⁻²hr⁻¹. Fouling of unmodified, hydroquinone-modified, and catechol-modified poly(tetrafuroethylene) (PTFE) microfiltration (MF) membrane is shown in the first plot. The membrane was operated using pure water for several minutes before feeding the oil emulsion to evaluate the pure water transmembrane pressure difference. All three membranes showed pure water transmembrane pressure difference of approximately 0.2 psi, suggesting that the coatings are thin enough that their application does not restrict flow through the relatively large pores of the MF membrane. Upon feeding the oil emulsion, the unmodified membrane showed a significant increase in transmembrane pressure difference of nearly eight psi over the 16-hour study. The hydroquinone- and catechol-modified membranes, in contrast, show relatively little change in transmembrane pressure difference over the same period. These results show that the hydroquinone- and catechol-modified membranes show much improved fouling resistance relative to the unmodified membrane.

In general, the transmembrane pressure differences for the ultrafiltration samples were higher than the similarly-modified microfiltration samples due to the much tighter pore structure of the ultrafiltration membrane.

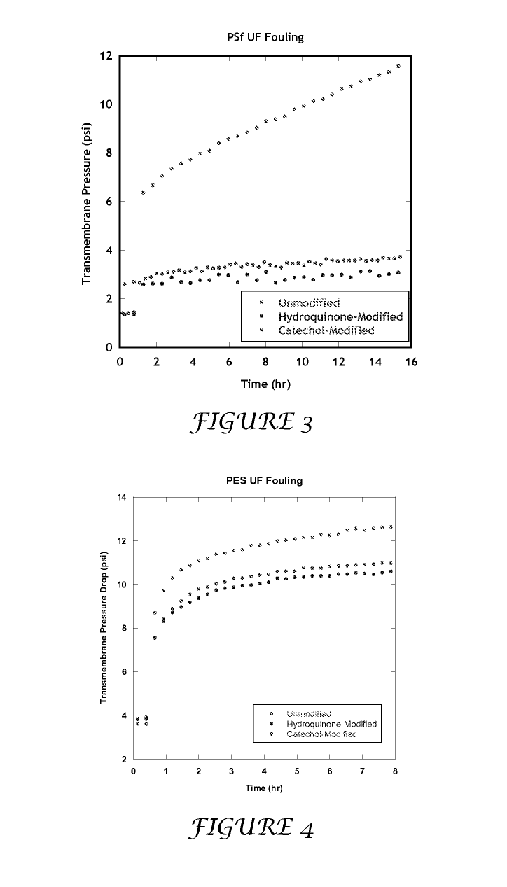

FIG. 3 is a graph of the fouling results for similarly-modified polysulfone (PSf) ultrafiltration (UF) membranes. Again, hydroquinone- and catechol-modified membranes are compared to unmodified membranes. The membranes were operated with only pure water for about one hour to evaluate their pure water transmembrane pressure difference. The unmodified membrane showed a pure water TMP of about 2.5 psi. The modified membranes, despite the addition of the hydroquinone and catechol coatings, showed lower pure water transmembrane pressure differences than the unmodified membrane. Upon feeding the oil emulsion fouling mixture, the unmodified membrane showed an increase in transmembrane pressure difference to 12 psi within 16 hours. In contrast, the transmembrane pressure difference of the hydroquinone- and catechol-modified samples remained below 4 psi over the same period.

FIG. 4 is a graph of the fouling results for Poly(ether sulfone) (PES) UF membranes showed similar results. After filtering only pure water several minutes, oil emulsion was fed to unmodified, hydroquinone-modified, and catechol-modified PES membranes for eight hours. The unmodified PES membrane showed a higher transmembrane pressure difference over the entire duration of the fouling study than the modified membranes.

Contact angles of unmodified, hydroquinone-modified, and catechol-modified PTFE MF, poly(vinylidene fluoride) (PVDF) MF, PSf UF, and PES UF membranes were measured. Hanging-drop contact angle measurements of air in water (for MF membranes) or decane in water (for UF membranes) are shown below. Contact angles were measured through the water phase; large contact angles (up to 180°) indicate hydrophobicity and small contact angles (down to 0°) indicate hydrophilicity. The hydroquinone coating increases the hydrophilicity of PTFE, PVDF, and PSf membranes but not the PES membrane. The catechol coating increases the hydrophilicity of PVDF and PSf membranes but does not increase the hydrophilicity of the PTFE and PES membranes.

Contact angles of unmodified and modified membranes are shown in the table below (degrees).

| | | Hydroquinone- | Catechol- |
|---|---|---|---|
| | Unmodified | Modified | Modified |
| PTFE | 121 ± 1 | 73 ± 2 | 120 ± 2 |
| PVDF | 34 ± 1 | 31 ± 1 | 25 ± 1 |
| PES | 79 ± 6 | 76 ± 2 | 84 ± 1 |
| PSf | 108 ± 2 | 94 ± 1 | 98 ± 1 |

The membranes include material: poly(tetrafluoroethylene); type: microfiltration; pore size: 0.22 μm; manufacturer: general electric; catalog number: f021p; material: poly(vinylidene fluoride); type: microfiltration; pore size: 0.22 μm; manufacturer: general electric; catalog number: m01wp; and material: poly(ether sulfone); type: ultrafiltration; pore size: 20 k da molecular weight cutoff; manufacturer: sepro; catalog number: pes-30; address: sepro membranes, inc.; 4115 avenida de la plata; oceanside, ca 92056; material: polysulfone; type: ultrafiltration; pore size: 20 k da molecular weight cutoff; manufacturer: sepro; catalog number: ps-20.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine studyation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue studyation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A method of decreasing membrane fouling comprising the steps of:
depositing a coating composition on a membrane to form a coated membrane, wherein the coating composition comprises hydroquinone, catechol, hydroquinone and catechol; hydroquinone and dopamine; catechol and dopamine, or hydroquinone; catechol, and dopamine, wherein the coated membrane has a higher water flux and an increased membrane surface hydrophilicity than an unmodified membrane.

2. The method of claim 1, wherein the pure water flux of the coated membrane comprises between 0 and 99% of the flux of the unmodified membrane.

3. The method of claim 1, wherein the pure water flux of the coated membrane comprises about 85% of the flux of the unmodified membrane.

4. The method of claim 1, wherein the dopamine comprises one or more substitutions selected from the addition of halogens, hydroxyl groups, lower alkyl groups, lower alkoxy groups, monocyclic aryl, lower acyl groups and combinations thereof.

5. The method of claim 1, wherein the membrane comprises a RO membrane, a UF membrane, a NF membrane, an MF membrane, or a combination thereof.

6. The method of claim 1, wherein the coated membrane comprises one or more of the following polymethylmethacrylates, polystyrenes, polycarbonates, polyimides, epoxy resins, cyclic olefin copolymers, cyclic olefin polymers, acrylate polymers, polyethylene teraphthalate, polyphenylene vinylene, polyether ether ketone, poly(N-vinylcarbazole), acrylonitrile-styrene copolymer, or polyetherimide poly(phenylenevinylene).

7. The method of claim 1, wherein the hydroquinone, catechol, and/or dopamine comprises one or more functional groups chosen from ROOH, ROSH, RSSH, OH, SO₃H, SO₃R, SO₄R, COOH, NH₂, NHR, NR₂, CONH₂, and NH—NH₂, wherein R denotes: linear or branched hydrocarbon-based chains, capable of forming at least one carbon-based ring, being saturated or unsaturated; alkylenes, siloxanes, silanes, ethers, polyethers, thioethers, silylenes, and silazanes.

8. The method of claim 1, wherein the coated membrane comprises one or more polysulfone, copolymer of styrene and acrylonitrile poly(arylene oxide), polycarbonate, cellulose acetate, polysulfones; poly(styrenes), styrene-containing copolymers, acrylonitrilestyrene copolymers, styrene-butadiene copolymers, styrene-vinylbenzylhalide copolymers; polycarbonates; cellulosic polymers, cellulose acetate-butyrate, cellulose propionate, ethyl cellulose, methyl cellulose, nitrocellulose, polyamides, polyimides, aryl polyamides, aryl polyimides, polyethers, poly(arylene oxides), poly(phenylene oxide), poly(xylene oxide); poly(esteramide-diisocyanate), polyurethanes, polyesters (including polyarylates), poly(ethylene terephthalate), poly(alkyl methacrylates), poly(acrylates), poly(phenylene terephthalate), polysulfides, poly(ethylene), poly(propylene), poly(butene-1), poly(4-methyl pentene-1), polyvinyls, poly(vinyl chloride), poly(vinyl fluoride), poly(vinylidene chloride), poly(vinylidene fluoride), poly(vinyl alcohol), poly(vinyl esters), poly(vinyl acetate), poly(vinyl propionate), poly(vinyl pyridines), poly(vinyl pyrrolidones), poly(vinyl ethers), poly(vinyl ketones), poly(vinyl aldehydes), poly(vinyl formal), poly(vinyl butyral), poly(vinyl amides), poly(vinyl amines), poly(vinyl urethanes), poly(vinyl ureas), poly(vinyl phosphates), poly(vinyl sulfates), polyallyls; poly(benzobenzimidazole), polyhydrazides, polyoxadiazoles, polytriazoles, poly(benzimidazole), polycarbodiimides, polyphosphazines and combinations thereof.

9. The method of claim 1, further comprising the step of applying one or more second coatings to the coated membrane.

10. The method of claim 1, further comprising the step of applying one or more hydrophilic coatings to the coated membrane.

11. A purification membrane comprising:
a purification membrane;
a coating layer in contact with the purification membrane to form a coated purification membrane with a high water flux, wherein the coating layer comprises hydroquinone, catechol, hydroquinone and catechol; hydroquinone and dopamine; catechol and dopamine, or hydroquinone; catechol, and dopamine, in contact with the coating layer to form a multi layer purification membrane.

12. The purification membrane of claim 11, wherein the flux of the coated purification membrane comprises between 0 and 99% of the flux of the unmodified purification membrane.

13. The purification membrane of claim 11, wherein the flux of the coated purification membrane comprises about 85% of the flux of the unmodified purification membrane.

14. The purification membrane of claim 11, wherein the dopamine comprises one or more substitutions selected from the addition of halogens, hydroxyl groups, lower alkyl groups, lower alkoxy groups, monocyclic aryl, lower acyl groups and combinations thereof.

15. The purification membrane of claim 11, wherein the purification membrane comprises a RO membrane, a UF membrane, a NF membrane, an MF membrane, or a combination thereof.

16. The purification membrane of claim 11, wherein the coated purification membrane comprises one or more of the following polymethylmethacrylates, polystyrenes, polycarbonates, polyimides, epoxy resins, cyclic olefin copolymers, cyclic olefin polymers, acrylate polymers, polyethylene teraphthalate, polyphenylene vinylene, polyether ether ketone, poly(N-vinylcarbazole), acrylonitrile-styrene copolymer, or polyetherimide poly(phenylenevinylene).

17. The purification membrane of claim 11, wherein the hydroquinone, catechol, and/or dopamine comprises one or more functional groups chosen from ROOH, ROSH, RSSH, OH, SO₃H, SO₃R, SO₄R, COOH, NH₂, NHR, NR₂, CONH₂, and NH—NH₂, wherein R denotes: linear or branched hydrocarbon-based chains, capable of forming at least one carbon-based ring, being saturated or unsaturated; alkylenes, siloxanes, silanes, ethers, polyethers, thioethers, silylenes, and silazanes.

18. The purification membrane of claim 11, wherein the coated purification membrane comprises one or more polysulfone, copolymer of styrene and acrylonitrile poly(arylene oxide), polycarbonate, cellulose acetate, polysulfones; poly(styrenes), styrene-containing copolymers, acrylonitrilestyrene copolymers, styrene-butadiene copolymers, styrene-vinylbenzylhalide copolymers; polycarbonates; cellulosic polymers, cellulose acetate-butyrate, cellulose propionate, ethyl cellulose, methyl cellulose, nitrocellulose, polyamides, polyimides, aryl polyamides, aryl polyimides, polyethers, poly(arylene oxides), poly(phenylene oxide), poly(xylene oxide); poly(esteramide-diisocyanate), polyurethanes, polyesters (including polyarylates), poly(ethylene terephthalate), poly(alkyl methacrylates), poly(acrylates), poly(phenylene terephthalate), polysulfides, poly(ethylene), poly(propylene), poly(butene-1), poly(4-methyl pentene-1), polyvinyls, poly(vinyl chloride), poly(vinyl fluoride), poly(vinylidene chloride), poly(vinylidene fluoride), poly(vinyl alcohol), poly(vinyl esters), poly(vinyl acetate), poly(vinyl propionate), poly(vinyl pyridines), poly(vinyl pyrrolidones), poly(vinyl ethers), poly(vinyl ketones), poly(vinyl aldehydes), poly(vinyl formal), poly(vinyl butyral), poly(vinyl amides), poly(vinyl amines), poly(vinyl urethanes), poly(vinyl ureas), poly(vinyl phosphates), poly(vinyl sulfates), polyallyls; poly(benzobenzimidazole), polyhydrazides, polyoxadiazoles, polytriazoles, poly(benzimidazole), polycarbodiimides, polyphosphazines and combinations thereof.

19. The method of claim 11, further comprising the step of applying one or more second coatings to the coated membrane.

20. The method of claim 11, further comprising the step of applying one or more hydrophilic coatings to the coated membrane.
